(19) United States
(12) Patent Application Publication
(10) Pub. No.: US 2021/0140402 A1
(43) Pub. Date: May 13, 2021

(54) SUBMERGED ELECTRICAL MACHINES

(71) Applicant: CURRENT KINETICS, LLC, Gainesville, FL (US)

(72) Inventor: John Paul SNINSKY, Gainesville, FL (US)

(21) Appl. No.: 16/639,473

(22) PCT Filed: Aug. 16, 2018
(86) PCT No.: PCT/IB2018/056207

§ 371 Date: Feb. 14, 2020

Related U.S. Application Data
(60) Provisional application No. 62/546,446, filed on Aug. 16, 2017.

(51) Int. Cl. F03B 17/06; F03B 13/10

(52) U.S. Cl. CPC F03B 17/061; F03B 13/10; F05B 2220/7068; F05B 2220/7066; F05B 2240/372

(57) ABSTRACT

Electrical machines as provided herein can include a shaftless rotor with an annular array of permanent magnets; and a stator with an annular ferromagnetic core and a plurality of electromagnetic inductors about the ferromagnetic core. The stator is located adjacent to and substantially co-axial with the shaftless rotor; and a fluid thrust bearing located in an axially planar gap between the stator and the shaftless rotor. The annular array of the permanent magnets of the shaftless rotor and the annular ferromagnetic core and electromagnetic inductors of the stator have a magnetic attraction that provides a co-axially centering force on the shaftless rotor.

### CROSS-REFERENCE TO RELATED APPLICATION

The present invention claims the benefit of U.S. Provisional Application Ser. 62/546,446, filed on Aug. 16, 2017, which is hereby incorporated by reference in its entirety, including any figures, tables, and drawings.

### BACKGROUND

Electric machines used for submerged applications, such as in-ship propulsion drives and hydrokinetic turbines, are often difficult to access and therefore costly to maintain. To reduce maintenance costs, such machines are typically designed to be highly reliable. Generally, these designs include seals forming watertight compartments that contain a gearbox or roller bearings; unfortunately, these components add mechanical drag, are prone to failure, and require periodic maintenance or replacement.

Some designs have increased reliability by eliminating the gearbox and direct-driving the rotor, however, these machines tend to be of large diameter in order to generate sufficient torque for low-speed operation. Conventionally, this architecture demands a heavy and rigid stator and rotor to maintain the small and stable airgap necessary between them, requiring high precision and costly fabrication techniques.

Despite the aforementioned design modifications for reliability and efficiency, alternative design solutions are necessary to further advance submerged electrical machines.

### BRIEF SUMMARY

Electrical machines with a shaftless rotor and methods of generating energy with the submerged electrical machines are described.

Electrical machines as provided herein can include a shaftless rotor with an annular array of permanent magnets; and a stator with an annular ferromagnetic core and a plurality of electromagnetic inductors about the ferromagnetic core. The stator is located adjacent to and substantially co-axial with the shaftless rotor; and a fluid thrust bearing located in an axially planar gap between the stator and the shaftless rotor. The annular array of the permanent magnets of the shaftless rotor and the annular ferromagnetic core and electromagnetic inductors of the stator have a magnetic attraction that provides a co-axially centering force on the shaftless rotor.

In some cases, the stator can include a plurality of modules where each module has a ferromagnetic core, a plurality of electromagnetic inductors, and a module mount. The module mount encloses at least a portion of the ferromagnetic core and the electromagnetic inductors. The stator further includes a retainer that is attached to a portion of the module mount of each module and links the plurality of modules into a radially annular shape. In some cases, the mount can allow pivoting motion of the individual modules to allow them to function as thrust pads in a tilt-pad thrust bearing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A is a perspective view of a hydrokinetic turbine or marine propulsor electrical machine.

FIG. 1B illustrates an example electrical machine.

FIG. 1C illustrates an example partial cross-sectional view of the example electrical machine of FIG. 1B.

FIG. 2 illustrates a cross-sectional view of a single-sided electrical machine with one shaftless rotor.

FIG. 3 illustrates a cross-sectional view of an example double-sided electrical machine with at least one shaftless rotor.

FIG. 4 illustrates a Stribeck curve as applied to and electrical machine using magnetic load reduction and having a shaftless rotor axially constrained by two thrust bearings.

FIG. 5A illustrates an implementation of a double-sided electrical machine.

FIG. 5B illustrates a cross-sectional view of an example double-sided electrical machine with at least one shaftless rotor.

FIG. 6 illustrates a cross-sectional view of an example double-sided electrical machine with two shaftless rotors.

FIG. 7 illustrates an implementation of a stator with individual modules.

FIG. 8 illustrates a section of an example stator with portions of the modules cut away for ease of viewing the internal components.

### DETAILED DISCLOSURE

Electrical machines with a shaftless rotor and methods of generating energy with the submerged electrical machines are described.

Advantageously, the described electrical machines do not require, and in many cases eliminate the need for, costly parts found on traditional electrical machines, namely, the gearbox, drive shaft, seals, and mechanical bearings. This also eliminates the maintenance and replacement of these parts.

In some cases, an electrical machine as provided herein can be an electric motor that converts electric energy into kinetic energy (e.g., using electricity to turn blades). These may be useful in boats, submarines, ships, and the like, including applications that require high torque production. In some cases, an electrical machine as provided herein can be a generator that converts kinetic energy into electricity (e.g., using the turning of the blades caused by an underwater current to generate electricity). These may be useful in an underwater current, such as, for example, the Gulf Stream, to collect electrical energy and provide that energy to a power grid or bank of batteries. In generator implementations, a machine side converter may operate in a symmetrical manner to control the generator to minimize torque pulsation, vibration, and noise. In utility scale applications, a grid side converter may be used to ensure production of symmetrical output to the power grid. The illustrated implementations described throughout the specification are applicable to motor and generator applications.

FIG. 1A is a perspective view of a hydrokinetic turbine or marine propulsor incorporating an example electrical machine; FIG. 1B illustrates an example electrical machine; and FIG. 1C illustrates an example partial cross-sectional view of the example electrical machine of FIG. 1B. The electrical machines described herein may be used to implement both turbines and propulsors depending on electrical and mechanical couplings. Electrical machine 100 includes a shaftless rotor 110 with an annular array of permanent magnets 118; and a stator 120 with an annular ferromagnetic core (see 122 of FIG. 1C) and a plurality of electromagnetic inductors (see 124 of FIG. 1C) about the ferromagnetic core. As used herein, “electromagnetic inductors about the ferromagnetic core’ and “electromagnetic inductors wound around a stator core” both refer to any useable form or design of inductors that at least partially surround a stator core, including, but not limited to, a toroidal winding or wave winding, with concentrated or distributed slots.

The stator 120 is located adjacent to and substantially co-axial with the shaftless rotor 110; and a fluid thrust bearing located in an axially planar gap 115 between the stator 120 and the shaftless rotor 110. The annular array of permanent magnets 118 may be arranged with spacing and sizing as suitable for maintaining appropriate magnetic attraction between the stator 120 and the rotor 110 for providing a co-axially centering force on the shaftless rotor 110.

The rotor can be considered to be “substantially” co-axial with a stator to within general tolerances permitting rotor flux linkage with the stator core.

When an electrical machine has permanent magnets 118 on only one side of the stator 120, it can be considered a single-sided electrical machine. For example, in the case where stator 120 is fixed to a component within the front outer housing 102, the example electrical machine of FIG. 1B may be considered to show a single-sided electrical machine with a shaftless rotor. In the case where rotor 110 has a component between the stator 120 and the front outer housing 102 (but the magnets 118 are only on the one side shown in FIG. 1B), the electrical machine may still be considered to show a single-sided electrical machine but a double-sided rotor. In some cases, such as described in more detail with respect to FIG. 3, the electrical machine can be a double-sided electrical machine with a double-sided rotor. In some implementations of double-sided electrical machines, the permanent magnets 118 can have offset magnet poles. The magnet poles may be offset from one side to the other to induce a sinusoidal motion of the modules. The offset magnet poles can cause the stator to experience unsymmetrical magnetic loads during operation, which induce oscillatory motion of a stator (and its modules) to enhance fluid film generation.

The unique configuration of the stator 120 and the shaftless rotor 110 provide an axially centering force on the shaftless rotor 110. The axially centering force provided for in this and other implementations do not need additional permanent magnets keep the shaftless rotor 100 and the stator 120 axially aligned, and the permanent magnets 118 provide dual use to also generate magnetic flux for the operation of the electrical machine. In addition, the shaftless rotor 110 does not require mechanical bearings to keep the stator 120 co-axially aligned with the shaftless rotor 110. Indeed, as shown, no mechanical bearings are included. Advantages to not including mechanical bearings include the reduction of mechanical drag, increased performance and efficiency, as well as lower capital and maintenance costs.

Electrical machine 100 is designed to be submerged in a liquid, such as, but not limited to, an ocean, tidal current, river, or lake. The electrical machine 100 may be housed within a front outer housing 102 and a back outer housing 104. The shaftless rotor 110 may include a plurality of outer blades 112 attached to an outer portion 114 (also referred to as a “radially outer edge”) of the shaftless rotor 110. The outer blades 112 may be equally spaced in relation to one another.

The shaftless rotor 110 may optionally include a plurality of inner blades 130 attached to an inner portion 132 of the shaftless rotor 110. The inclusion of inner blades can be useful in larger-sized electrical machines 100 that have a relatively large inner diameter, such that energy from water passing through the inner portion 132 can be collected in response to motion by the plurality of inner blades 130. The plurality of inner blades 130 may also provide the dual-use of structural stiffness to the shaftless rotor 110.

A method of producing electricity can include submerging a plurality of electrical machines in an underwater current, each electrical machine comprising: a shaftless rotor comprising an annular array of permanent magnets; a stator comprising an annular ferromagnetic core and a plurality of electromagnetic inductors about the ferromagnetic core, the stator being located adjacent to and substantially co-axial with the shaftless rotor; and a fluid thrust bearing located in an axially planar gap between the stator and the shaftless rotor. The plurality of electrical machines can be coupled to a power grid or battery bank. When the shaftless rotor of an electrical machine rotates in response to the underwater current, the rotation of the shaftless rotor can be converted into electricity by the plurality of electromagnetic inductors of that electrical machine.

In some cases, where the electrical machine functions as a motor, the plurality of inner blades 130 can be provided such that water can be moved to provide propulsion through the water.

In some cases, as briefly mentioned above, the electrical machine 100 can be a double-sided electrical machine. It should be noted that “double-sided” refers to an electrical machine that has permanent magnets on each side of a stator. Because each side of a double-sided electrical machine has permanent magnets, it may also include two independent, separate rotors, however, it should be noted that some implementations of a double-sided electrical machine have a single rotor (referred to herein as a “double-sided rotor” or “double-sided shaftless rotor”).

As can be seen, there are no contacts between the rotor and the stator, so the electrical machines described throughout this specification are considered to be “brushless” machines.

FIG. 2 illustrates a cross-sectional view of a single-sided electrical machine with one shaftless rotor. Turning now to FIG. 2, a cross-sectional view of an electrical machine 200 with a shaftless rotor 210 is illustrated. The shaftless rotor 210 includes two or more permanent magnets 212 that may be attached to a rotor yoke 214. The rotor yoke 214 may be made of a ferromagnetic material. The electrical machine 200 also includes a stator 220. The stator 220 may include electromagnetic inductors 222 wound around a stator core 224. The stator core 224 may be made of a ferromagnetic material.

In this embodiment, cavities A, C, and E are inundated with liquid when submerged. Cavities A and E provide a fluid thrust bearing between the shaftless rotor 210 and the stator 220, as well as the shaftless rotor and a stator yoke 232. When submerged in a liquid during operation, a thick film lubricant may be generated between the shaftless rotor 210 in the stator 220 (in cavity A). A thick film lubricant may also be generated between the shaftless rotor 210 and the stator yoke 232 (in cavity E). As can be seen, there are no mechanical bearings, shafts, or the like to keep the shaftless rotor 210 in axial alignment with the stator 220; the axially centering force is provided for by the magnetic attraction between the two or more permanent magnets 212 of the shaftless rotor 210 and the ferromagnetic stator core 224 of the stator 220. Design choices of the size and strength of the permanent magnet and the ferromagnetic material used will be a function of the desired magnetic field strength and magnetic flux density needed to keep the shaftless rotor 210 axially aligned with the stator 220 during operation in a submerged environment. One way that may be provided to make the axial alignment of the shaftless rotor 210 with the stator 220 easier is to make the shaftless rotor 210 neutrally buoyant when submerged in a liquid.

Furthermore, the stator core 224 and the electromagnetic inductors 222 may be attached to a stator structural support 226, which provides structural support to the stator 220. The stator structural support 226 may be made of any number of materials, including, but not limited to, composite, foam, non-conductive metal alloy, or other non-conductive material. The stator structural support 226 may be attached to an elastomer or rubber material 228. The elastomer or rubber material 228 may be utilized to absorb any vibrations or movement from the stator 220 while the electrical machine 200 is in operation, as well as to allow a module to tilt/pivot as a tilt pad bearing pad (forming a converging wedge to pressurize fluid). The elastomer or rubber material 228 may be a mechanism known in the art to allow pad tilt. A non-modular stator does not require this attachment mechanism and may be mounted directly to retainer 230. In other implementations, the elastomer or rubber material 228 may be a metal rocker mechanism to provide tilt pad functionality. The elastomer or rubber material 228 may attach to a retainer 230. The retainer 230 may be made of any material that is suitable to attach to the stator 220 and be able to withstand the environment which it is designed for, such as freshwater or seawater, as would be appreciated by those skilled in the art. In addition, because the rotor yoke 214 may be magnetically saturated, the stator yoke 232 may magnetically link with the magnetic flux of the permanent magnets 212 of the shaftless rotor 210 to provide additional axially aligning forces to the shaftless rotor 210. The magnetic saturation of the rotor yoke 214 and magnetic linkage of the magnetic flux with the stator yoke 232 can reduce thrust load experienced by the fluid thrust bearing during use.

FIG. 3 illustrates a cross-sectional view of an example double-sided electrical machine with at least one shaftless rotor. Referring to FIG. 3, a double-sided electrical machine 300 is shown with a left and right side of a shaftless rotor 311, 321. The left side of the shaftless rotor 311 includes at least two permanent magnets 312 attached to a rotor yoke 314. The rotor yoke 314 may be made of ferromagnetic material. The right side of the shaftless rotor 321 includes at least two permanent magnets 322 attached to a rotor yoke 324. The rotor yoke 324 may be made of ferromagnetic material.

The double-sided electrical machine 300 further includes a stator 330. The stator 330 includes a ferromagnetic core 332 and electromagnetic inductors 334 wound around the ferromagnetic core 332. As can be seen, there are no mechanical bearings, shafts, or the like to keep each side of the shaftless rotor 311, 321 in axial alignment with the stator 330; the axially centering force is provided for by the magnetic attraction between the two or more permanent magnets 312, 322 of each side of the shaftless rotor 311, 321 and the electromagnetic inductors 334 and the stator core 332 of the stator 330. Design choices of the size and strength of the permanent magnet and the ferromagnetic material used will be a function of the desired magnetic field strength and magnetic flux density needed to keep each side of the shaftless rotor 311, 321 axially aligned with the stator 330 during operation in a submerged environment. One way that may be provided to make the axial alignment of each side of the shaftless rotor 311, 321 with the stator 330 easier is to make each side of the shaftless rotor 311, 321 neutrally buoyant when submerged in a liquid.

During operation of the electrical machine 300, blades (not shown) produce and transfer hydrodynamic axial thrust load to at least one side of the shaftless rotor 311, 321, which then transfers the axial thrust load to the stator 330. To inhibit contact between either side of the rotor 311, 321 and the stator 330, a thrust bearing comprising a layer of pressurized fluid is generated in at least one of the cavities A and B.

The stator 330 may be attached to a retainer 340 at location D. Location D may be made of a non-conductive material, such as a composite or the like that allows for pad tilt. In this implementation, the retainer 340 is attached to an outer portion of the stator 330. As an alternative, as previously mentioned with respect to FIG. 2 and further described in more detail with regards to FIG. 8, a retainer may be attached to an inner portion of a stator or an outer portion of a stator (depending on implementation) to allow for pad tilt.

In addition, the rotor structural members 316, 326 are structurally attached to one another by rotor structural member 328; the plurality of structural members 316, 326, 328 are connected by rotor structural fastener 350; and the retainer 340 is attached to an outer portion of the stator 330.

In some cases, the structural members 316, 326, 328 are one composite piece, eliminating the need for rotor structural fastener 350. The structural members 316, 326, 328 provide more structural support for each side of the shaftless rotor 311, 321 and the stator 330 during operation of the electrical machine 300. Furthermore, even though the structural member 328 may inhibit the stator 330 from moving out of the electrical machine 300, cavity C allows for radial translation and rotation of the stator 330 while keeping the electrical machine 300 from being ripped apart during a catastrophic event, such as a hurricane or tsunami level event or impact with another object. In addition, the retainer 340 can be configured to allow for pad tilt.

FIG. 4 illustrates a Stribeck curve as applied to an electrical machine using magnetic load reduction with a shaftless rotor(s) axially constrained by two thrust bearing faces. As can be seen, the coefficient of friction is a function of rotor velocity and thrust load. When velocity of a rotor in relation to a stator is zero, the thrust bearing is in the boundary layer. The boundary layer is characterized by high friction, and the axially facing surfaces of the stator and the rotor may come into contact, with the thrust load being substantially supported by surface asperities.

As the velocity of the rotor begins to increase, the thrust bearing may move into the mixed mode layer. In the mixed mode layer, there may be some contacting of the axially facing surfaces of the stator and rotor, and the thrust load will be supported by both the contacting of the axially facing surfaces of the stator and the rotor as well as the liquid lubricant. As the velocity of the rotor increase and the thrust bearing moves from closer to the boundary layer towards the hydrodynamic layer, more of the thrust load will be supported by the liquid lubricant. Furthermore, the coefficient of friction between the axially facing surfaces of the stator and the rotor becomes substantially lower.

As the velocity of the rotor continues to increase, the thrust bearing moves into the hydrodynamic layer. In the hydrodynamic layer, the contact between the axially facing surfaces of the stator and the rotor do not touch, or, if they do, the contact is negligible. Furthermore, the thrust load is completely (or at least substantially) supported by the liquid lubricant. As can be seen in this Stribeck curve, the coefficient of friction is approximately 100 times lower than it was when the rotor velocity was at zero. At this point, the bearing thrust load is also negligible and the liquid lubricant in the thrust bearing can be said to have become a thick film fluid thrust bearing. As can be seen, as the rotor velocity continues to increase, the thrust bearing enters an upper mixed mode layer and then into an upper boundary layer. Therefore, the key is to design an electrical machine that provides sufficiently high rotor velocities and sufficiently low thrust loads to allow the thrust bearing to become a thick film fluid thrust bearing within the cut-in and cut-out operating range of the machine.

As will be understood by those skilled in the art, the cut-in and cut-out refer to the range with which the turbine is designed to apply electromagnetic torque and generate electricity. Before reaching the cut-in range, the electrical machine is typically braked, and the current velocity is too low to produce effective power or overcome internal generator cogging forces. Once into the cut-out range, the electrical machine maintains RPM to “stall out” the blades and reduce load on the machine (electrical and structural). As can be seen, this Stribeck curve includes a combination of two curves back to back (representing two thrust bearings). Once the machine passes the neutral thrust load point (delineated by the vertical dashed line in FIG. 4), the opposite thrust bearing is loaded. This way the rotor floats or alternates between two thrust bearing surfaces (e.g., between thrust bearing A and B in FIG. 3). This effectively splits the load each independent thrust bearing sees and splits any wear between two bearing surfaces.

It should be further understood that the Stribeck curve described above may apply to any of the fluid thrust bearings described herein.

As will be described in more detail herein, the magnitude of the thrust load may be manipulated using a permanent magnet flux circuit to pre-load the fluid thrust bearing. The pre-loading can be used to achieve the thick fluid film thrust bearing between a stator and a rotor at low sliding speeds (such as those found in direct drive hydrokinetic turbine applications). This may be achieved in two ways (in combination or separately): The first way is to geometrically design the electrical machine asymmetrically, such that the magnetic load from each rotor side to the wound stator core is made different, for example through unequal flux densities or a hybrid slotted and slotless configuration between the sides. The second way is to utilize a stator yoke, with the rotor yoke being magnetically saturated by the permanent magnets of the rotor and utilizing an isolated stator yoke that is positioned in a direction that would reduce the net load on the fluid thrust bearing. In this configuration, the rotor's magnetic flux will link with the isolated stator yoke, introducing a magnetic force in opposition to the blade thrust loads.

FIG. 5A illustrates an implementation of a double-sided electrical machine; and FIG. 5B illustrates a cross-sectional view of an example double-sided electrical machine with at least one shaftless rotor. A double-sided electrical machine 500 can include a double-sided shaftless rotor 510 with a left side 510A and a right side 510B disposed on opposite sides of a stator 530.

Each shaftless rotor side 510A, 510B includes an array of permanent magnets 512, 514 (512 only shown in FIG. 5B because of the angle of the view in FIG. 5A). The array of permanent magnets 512, 514 form an annular shape. Of course, implementations are not limited thereto so long as the interaction between the magnets 512, 514 and the ferromagnetic core (516, 520 shown in FIG. 5B) of the stator 530 provide an axially centering force. The annular array of permanent magnets 512, 514 of each rotor side 510A, 510B may be housed, at least in part, by a rotor yoke 516, 520.

The stator 530 includes a ferromagnetic core 532 and electromagnetic inductors 534 wound around the ferromagnetic core 532. As can be seen, there are no mechanical bearings, shafts, or the like to keep the shaftless rotor 510 in axial alignment with the stator 530; the axially centering force is provided for by the magnetic attraction between the two or more permanent magnets 514 of the shaftless rotor 510 and the electromagnetic inductors 534 and the stator core 532 of the stator 530. Stator 530 may also include a stator yoke 536, which can be used for load control. In some of such cases, the stator yoke 536 includes ferromagnetic material, and receives flux from magnetically saturated left rotor yoke 516.

The stator 530 may include a plurality of modules 531 such as described with respect to stator 700 and 800 of FIGS. 7 and 8. Each of the plurality of modules may include a ferromagnetic core (532 shown in FIG. 5B), a plurality of electromagnetic inductors (534 shown in FIG. 5B), and stator module mount 521 (represented as location D in FIG. 5B). The plurality of modules to 531 may be held together by a stator retainer 540.

As illustrated in FIG. 5B, the left side of permanent magnets 512 may be attached to the left rotor yoke 516, which may be made of ferromagnetic material. The left rotor yoke 516 may be magnetically saturated by the left side of permanent magnets 512. In this embodiment, the left rotor yoke 516 is attached to left rotor structural member 518. The right side of permanent magnets 514 may be attached to a right rotor yoke 520, which may also be made of ferromagnetic material. The right rotor yoke 520 may not be magnetically saturated by the right side of permanent magnets 514. In other implementations with a stator yoke immediately adjacent to the right rotor yoke 520, the right rotor yoke 520 may be magnetically saturated. In this embodiment, the right rotor yoke 520 is attached to right rotor structural member 522. The rotor structural members 518, 522 may be made of a composite material, foam, non-conductive metal alloy, or other non-conductive material that may still be magnetically attracted to a magnet. The magnetic saturation of the left rotor yoke 516 may be desirable to provide a leakage of magnetic flux so that the left side of permanent magnets 512 are magnetically attracted to the stator yoke 536, thereby reducing a thrust load experienced on the left axial surface of the stator 530, as well as providing additional axially aligning forces to the shaftless rotor 510.

Design choices of the size and strength of the permanent magnet and the ferromagnetic material used for the rotor(s) and stator will be a function of the desired magnetic field strength and magnetic flux density needed to keep the shaftless rotor 510 axially aligned with the stator 530 during operation in a submerged environment. One way that may be provided to make the axial alignment of the shaftless rotor 510 with the stator 530 easier is to make the shaftless rotor 510 neutrally buoyant when submerged in a liquid.

The stator 530 may be attached to a retainer 540 at location D. Location D may be made of a non-conductive material, such a composite or the like that allows for pad tilt. The rotor structural members 518, 522 are structurally attached to one another by rotor structural member 524. The plurality of structural members 518, 522, 524 are connected by rotor structural fastener 526. In other implementations, the structural members 518, 522, 524 are one composite piece, eliminating the need for rotor structural fastener 524. The structural members 518, 522, 524 provide more structural support to the shaftless rotor 510 during operation of the electrical machine 500. Furthermore, even though the structural member 524 may prevent the stator 530 from moving out of the electrical machine 500, cavity C allows for radial translation and rotation of the stator 530 while keeping the electrical machine 500 from being ripped apart during a catastrophic event, such as a hurricane or tsunami level event or impact with another object.

One or both of the shaftless rotor sides 510A, 510B may also include a plurality of blades 552. In the example illustration, the plurality of blades 552 are attached to an outer portion of the shaftless rotor 510B on a back outer housing 550.

It should also be noted that, in double sided machines (as described above and throughout herein), axial thrust generated by a plurality of blades may be balanced by internal rotor-to-stator magnetic forces to enhance the operation of a fluid bearing. In such a topology, the fluid film thrust bearing is magnetically pre-loaded so that the fluid film pressure required to support a thrust load at machine operating speeds is reduced.

During operation of the electrical machine 500, blades (e.g., 522) produce and transfer hydrodynamic axial thrust load to the shaftless rotor 510, which then transfers the axial thrust load to the stator 530. To prevent contact between the rotor 510, the stator 530, and/or the stator yoke 536, a thrust bearing comprising a layer of pressurized fluid is generated in at least two of cavities A, B and E. In this embodiment, a thick film fluid thrust bearing may always be generated in cavity A. A thick film fluid thrust bearing may be generated in cavity B or E, but not both. In other implementations, a thick film fluid thrust bearing may be generated in cavities A, B, and E. In these and other implementations, at least one thick fluid film may be generated in any of the cavities A, B, and E and may change, for example, from being generated in cavity A and B to being generated in cavity A and E, depending on configurations of the stator 530 and rotor 510 and/or environmental forces, such as, for example, directions of underwater currents. Furthermore, the axial thickness of the rotor yoke 516 is proportional to the desired amount of thrust load reduction to the stator 530.

FIG. 6 illustrates a cross-sectional view of an example double-sided electrical machine with two shaftless rotors. Referring to FIG. 6, a double-sided electrical machine 600 is shown with a first and a second shaftless rotor 610, 620. Including two shaftless rotors is desirable to allow for contra-rotation of the first and second shaftless rotors 610, 620. The first shaftless rotor 610 includes at least two permanent magnets 612 attached to a rotor yoke 614. The rotor yoke 614 may be made of ferromagnetic material. The second shaftless rotor 620 includes at least two permanent magnet 622 attached to a rotor yoke 624. The rotor yoke 624 may be made of ferromagnetic material.

The double-sided electrical machine 600 further includes a stator 630. The stator 630 includes a ferromagnetic core 632 and electromagnetic inductors 634 wound around the ferromagnetic core 632. As can be seen, there are no mechanical bearings, shafts, or the like to keep the shaftless rotors 610, 620 in axial alignment with the stator 630; the axially centering force is provided for by the magnetic attraction between the one or more permanent magnets 612, 622 of the shaftless rotors 610, 620 and the electromagnetic inductors 634 and the stator core 632 of the stator 630. Design choices of the size and strength of the permanent magnet and the ferromagnetic material used will be a function of the desired magnetic field strength and magnetic flux density needed to keep the shaftless rotors 610, 620 axially aligned with the stator 630 during operation in a submerged environment. One way that may be provided to make the axial alignment of the shaftless rotors 610, 620 with the stator 630 easier is to make the shaftless rotors 610, 620 neutrally buoyant when submerged in a liquid.

During operation of the electrical machine 600, blades (not shown) produce and transfer hydrodynamic axial thrust load to the shaftless rotors 610, 620, which then transfers the axial thrust load to the stator 630. To inhibit contact between the rotors 610, 620 and the stator 630, a thrust bearing comprising a layer of pressurized fluid is generated in cavities A and B.

The stator 630 may be attached to a retainer 640 at location D. Location D may be made of a non-conductive material, such as a composite or the like that allows for pad tilt. In this implementation, the retainer 640 is attached to an inner portion of the stator 630. By providing the retainer 640 at the inner portion of the stator 630, blades may be able to be attached more directly to outer portions of the rotors 610, 620. In addition, as previously discussed and as discussed with regards to FIG. 8, a retainer may be attached to an inner portion of a stator or an outer portion of a stator (depending on implementation) to allow for pad tilt.

It should be noted that in implementations with two rotors, each of the rotors can have a corresponding set of blades, and when the two rotors are not coupled together in the form of a double-sided rotor, the blades may spin in contra-rotation in relation to one another. In some of such cases, the electromagnetic inductors of the stator are wound such that the machine electrical waveform is substantially sinusoidal when both rotors rotate in sync (e.g., with the same RPM) for a generator. This same winding allows the rotors to rotate in sync and at the same RPM when operated as a motor. This allows for contra-rotation of the shaftless rotor in relation to the second shaftless rotor.

FIG. 7 illustrates an implementation of a stator with individual modules. Referring to FIG. 7, a stator 700 is illustrated that includes a plurality of modules 710 attached to a retainer 720. The plurality of modules 710 attach together to form an annular ring shape. Each module of the plurality of modules 710 may be attached together in such a way so as to allow individual replacement of the stator module. The attachment may further provide the ability to replace each of the plurality of modules while the stator 700 remains submerged in a liquid. In some cases, the stator retainer 720 may be attached to the plurality of modules 710 in such a way to allow for pivoting about an in-plane axis or point about the stator retainer 720 so that the stator 700 can serve as a dual-purpose tilt pad (i.e., tilt about the stator retainer 720 in a manner known by those skilled in the art of tilt pad bearings). In addition, the retainer 720 may be attached to an inner portion of the plurality of stator modules 720 (instead of the outer diameter, as is shown in FIG. 7).

Furthermore, each of the plurality of modules 710 may include wet-mate connectors to combine together, where the actual type of wet-mate connector may be chosen based on desired pressure, depth, and voltage ratings. Each of these advantages may be important if one of the modules electrical fault or “shorts out.” If one of the modules shorts out, a generator/motor controller can isolate that module and continue to operate without that module until maintenance can be scheduled to replace that module.

FIG. 8 illustrates a section of an example stator with portions of the modules cut away for ease of viewing the internal components. Referring to FIG. 8, a section of a stator 800 is shown. In this section, five modules can be seen; modules 801, 802, and 803 are fully intact while modules 810 and 820 illustrate modules that have portions cut away for ease of viewing internal components. Obviously, these portions would not be cut away in a completed stator. In a completed stator, each of the modules would contain all of the portions shown in each of the modules 801, 802, 803, 810, 820. As can be seen in module 810, a plurality of electromagnetic inductors 812 are exposed. As can be seen in module 820, a ferromagnetic core 814 lies within the electromagnetic inductors 812. A layer of epoxy or insulation material may also surround the plurality of electromagnetic inductors 812. Each of the modules 801, 802, 803 are also seen with a lubricous, abrasion resistant, watertight casing 805 around them, the watertight casing 805 suited for use as a thrust-pad.

As can be seen in modules 801, 810, and 820, a stator mount 840 attaches each of the modules to a retainer 830. The retainer 830 may be a solid structure, such as steel, hard plastic, or other material that provides adequate structural support for the size and environment in which the stator will be used in, as will be appreciated by those skilled in the art.

Filling the space between each of the plurality electromagnetic inductors 812 are fingers (“finger portions”) 842 of the stator mount 840. The fingers 842 extend, from an outer portion, radially inward towards an inner diameter of the modules. In “slotless” electrical machines, the fingers 842 may be made of a non-magnetic, non-conductive composite that are used primarily to provide structural support to the ferromagnetic core 814 and the electromagnetic inductors 812. In “slotted” electrical machines, the fingers 842 may be made of ferromagnetic material (such as the same ferromagnetic material the ferromagnetic core 814 is made of). For slotted electrical machines, the fingers may be shorter in stature and be in the form of teeth or other suitable structure in the space between inductors. In either case, the fingers 842 can fill the space between each of the electromagnetic inductors 842.

Furthermore, as can be seen in the cross-sectional cut away of module 801, a hard spine 844 may be included around an outer portion 846 of the stator mount 840. The hard spine 844 may be made of a metal alloy, hard composite or other similar material for rigidity. The stator mount 840 may be made of a structural material such as composite, the outer portion 846, may be made of a rubber or elastomer type of material. The attachment of the stator mount 840 and the hard spine 844 may provide for an attachment that allows some rotation and translation such that, when used in operation, a formation of a converging wedge between the modules and an adjacent rotor to pressurize of a fluid to maintain a symmetric pressure profile on the axial surface facing the adjacent rotor is generated. This function during use of the stator 800 is similar to the function of a tilt-pad, wherein each module would function equivalently to a pad or shoe in a tilt pad. This allows the stator 800 to perform two functions normally provided for by two different objects in a traditional driveline including an axial-flux electrical machine: the function of a stator and the function of a tilt pad thrust bearing. In other words, instead of having a separate thrust bearing and a traditional electrical machine stator, the stator comprises a plurality of modules that, because of their connection around a solid annular ring (in this embodiment, the retainer 830), serves a dual-purpose function as a tilt pad bearing.

It should be noted that in some cases, the plurality of modules may be connected around a solid annular ring to an inside diameter or from an axially facing surface of the modules. These connections may allow for the same tilt needed to allow the plurality of stator modules to serve dual-purpose function as a tilt pad.

It should also be noted that the stator described in FIGS. 7 and 8 may be used in other implementations of the electrical machine, such as those described in FIGS. 1-6. Of course, the stators described with respect to FIGS. 1-6 may instead be formed of a single, non-modular unit (or be partly formed of modular units). A stator configuration without modules may be desired in smaller electrical machines where tilt pad functionality is not needed.

What is claimed is:

1. An electrical machine, comprising:
a shaftless rotor comprising an annular array of permanent magnets;
a stator comprising an annular ferromagnetic core and a plurality of electromagnetic inductors about the ferromagnetic core, the stator being located adjacent to and substantially co-axial with the shaftless rotor; and
a fluid thrust bearing located in an axially planar gap between the stator and the shaftless rotor;
wherein the annular array of the permanent magnets of the shaftless rotor and the annular ferromagnetic core and electromagnetic inductors of the stator have a magnetic attraction that provides a co-axially centering force on the shaftless rotor.

2. The electrical machine of claim 1, wherein the shaftless rotor further comprises a radially outer edge comprising a plurality of blades, the plurality of blades being equally spaced in relation to one another.

3. The electrical machine of claim 1, further comprising a second shaftless rotor comprising an annular array of permanent magnets,

4. The electrical machine of claim 3, wherein, during operation, the second shaftless rotor rotates in a contra-rotational direction in relation to the shaftless rotor.

5. The electrical machine of claim 4, wherein the electromagnetic inductors of the stator are wound to enable a substantially sinusoidal electrical waveform with contra-rotation of the shaftless rotor in relation to the second shaftless rotor.

6. The electrical machine of claim 1, wherein the annular array of permanent magnets of the shaftless rotor further comprises offset magnet poles.

7. The electrical machine of claim 1, further comprising a rotor yoke coupled to the shaftless rotor, wherein the rotor yoke comprises ferromagnetic material.

8. The electrical machine of claim 7, wherein an axial thickness of the ferromagnetic material of the rotor yoke with regards to a strength of the permanent magnets is proportional to a desired thrust load reduction.

9. The electrical machine of claim 7, wherein the ferromagnetic material of the rotor yoke is magnetically saturated such that a rotor flux magnetically links with a stator yoke of the stator to reduce thrust load experienced by the fluid thrust bearing during use.

10. The electrical machine of claim 1, wherein, during operation, the fluid thrust bearing creates a thick fluid film between the shaftless rotor and the stator.

11. The electrical machine of claim 1, wherein the shaftless rotor further comprises a plurality of blades around a radially inner edge, the blades being equally spaced in relation to one another.

12. The electrical machine of claim 1, wherein, when submerged in a liquid, the shaftless rotor is neutrally buoyant.

13. The electrical machine of claim 2, wherein, during operation, the co-axially centering force opposes a thrust load generated by the plurality of blades

14. The electrical machine of claim 1, wherein a rotor yoke allows for radial displacement of the shaftless rotor during operation.

15. The electrical machine of claim 1, wherein the annular ferromagnetic core of the stator comprises a plurality of annular ferromagnetic cores, wherein the stator comprises a plurality of modules, each module comprising a core of the plurality of annular ferromagnetic cores and a subset of the plurality of the electromagnetic inductors.

16. The electrical machine of claim 15, wherein each module of the plurality of modules are linked together to form a radially annular shape.

17. The electrical machine of claim 15, wherein the stator comprises an annular shaped retainer, each module being coupled to the annular shaped retainer.

18. The electrical machine of claim 1, wherein the stator comprises a first axially facing surface and a second axially facing surface, the first axially facing surface being on an opposite side of the stator from the second axially facing surface, wherein a flux density or slot topology is different on the first axially facing surface than the second axially facing surface.

19. A stator, comprising:
a plurality of modules, each module comprising:
a ferromagnetic core;
a plurality of electromagnetic inductors; and
a module mount enclosing at least an outer portion of the ferromagnetic core and the electromagnetic inductors; and
a retainer that is attached to a portion of the module mount of each module, the retainer linking the plurality of modules into a radially annular shape.

20. The stator of claim 19, wherein, during operation, each of the modules are attached by the module mount to the retainer in way that allows for rotational movement of each module about the retainer, the rotational movement allowing for:
formation of a converging wedge between the modules and an adjacent rotor; and
pressurization of a fluid to maintain a symmetric pressure profile on the axial surface facing the adjacent rotor.

21. The stator of claim 19, wherein the module mount comprises finger portions that extend radially inward and provide grooves in which the electromagnetic inductors are positioned.

22. The stator of claim 19, wherein the modules are individually replaceable.

23. A method of producing electricity, comprising:
submerging a plurality of electrical machines in an underwater current, each electrical machine comprising:
a shaftless rotor comprising an annular array of permanent magnets;
a stator comprising an annular ferromagnetic core and a plurality of electromagnetic inductors about the ferromagnetic core, the stator being located adjacent to and substantially co-axial with the shaftless rotor; and
a fluid thrust bearing located in an axially planar gap between the stator and the shaftless rotor;
wherein the annular array of the permanent magnets of the shaftless rotor and the annular ferromagnetic core and electromagnetic inductors of the stator have a magnetic attraction that provides a co-axially centering force on the shaftless rotor;
coupling the plurality of electrical machines to a power grid or battery bank; and
converting rotation of the shaftless rotors that are rotating in response to the underwater current into electricity by the plurality of electromagnetic inductors of corresponding electrical machines.
